(19) United States
(12) Patent Application Publication
(10) Pub. No.: US 2025/0393018 A1
(43) Pub. Date: Dec. 25, 2025

(54) DETERMINING GEO-LOCATION OF USER DEVICE(S) IN A MULTI-RADIO DISTRIBUTED WIRELESS COMMUNICATIONS SYSTEM (WCS) USING MEASURED UPLINK POWER IN RADIO UNITS(RUs) ON A PER USER DEVICE BASIS

(71) Applicant: ANI Acquisition Sub, LLC, Boca Raton, FL (US)

(72) Inventors: Naveen Aggarwal, Delhi (District Shahdara) (IN); Sukhvinder Singh Malik, Sonipat (IN); Atul Singh, Noida (IN)

(73) Assignee: ANI Acquisition Sub, LLC, Boca Raton, FL (US)

(21) Appl. No.: 19/249,740

(22) Filed: Jun. 25, 2025

Related U.S. Application Data
(60) Provisional application No. 63/663,858, filed on Jun. 25, 2024.

(51) Int. Cl. H04W 64/00; H04B 17/318; H04L 5/00; H04W 72/12

(52) U.S. Cl. CPC H04W 64/00; H04B 17/318; H04L 5/0051; H04W 72/12

(57) ABSTRACT

Determining geo-location of user devices in a multi-radio distributed wireless communication system (WCS) using measured uplink power in radio units (RUs) on a per user device basis is disclosed. Active user devices in the WCS are scheduled to transmit an uplink reference signal (e.g., a sounding reference signal (SRS)) at different times so that uplink power in the uplink reference signal received by multiple RUs can be analyzed on a per user device basis. The measured uplink power of a received uplink reference signal in each RU can be measured in the time domain before any combining of uplink communication signals and then reported to create a user device report. The user device report includes the measured uplink power in multiple RUs that each received the uplink reference signal transmitted by the scheduled remote unit that can be analyzed to determine the geo-location of the user device within the WCS.

### CROSS-REFERENCE TO RELATED APPLICATIONS

This application claims the benefit of priority under 35 U.S.C. § 119 (e) of U.S. Provisional Application No. 63/663,858, filed Jun. 25, 2024, the contents of which are incorporated herein by reference in its entirety.

### BACKGROUND

The disclosure relates generally to determining the geo-location of user devices in a multi-radio distributed wireless communications system (WCS), which can include a fifth generation (5G) system, a 5G new-radio (5G-NR) system, and/or a distributed communications system (DCS).

Wireless communication is rapidly growing, with ever-increasing demands for high-speed mobile data communication. As an example, local area wireless services (e.g., so-called “wireless fidelity” or “WiFi” systems) and wide area wireless services are being deployed in many different types of areas (e.g., coffee shops, airports, libraries, etc.). Communication systems have been provided to transmit and/or distribute communication signals to wireless devices called “clients,” “client devices,” or “wireless client devices,” which must reside within the wireless range or “cell coverage area” in order to communicate with an access point device. Example applications where communications systems can be used to provide or enhance coverage for wireless services include public safety, cellular telephony, wireless local access networks (LANs), location tracking, and medical telemetry inside buildings and over campuses. One approach to deploying a communications system involves the use of a radio node/base station that transmits communications signals distributed over physical communications medium remote unit forming radio frequency (RF) antenna coverage areas, also referred to as “antenna coverage areas.” The remote units each contain or are configured to couple to one or more antennas configured to support the desired frequency(ies) of the radio node to provide the antenna coverage areas. Antenna coverage areas can have a radius in the range from a few meters up to twenty meters, as an example. Another example of a communications system includes radio nodes, such as base stations, that form cell radio access networks, wherein the radio nodes are configured to transmit communications signals wirelessly directly to client devices without being distributed through intermediate remote units.

Operators of mobile systems, such as UMTSs and its offspring, including LTE and LTE-Advanced, are increasingly relying on wireless small cell RANs in order to deploy, for example, indoor voice and data services to enterprises and other customers. Such small cell RANs typically utilize multiple-access technologies capable of supporting communications with multiple users using RF signals and sharing available system resources such as bandwidth and transmit power. Evolved universal terrestrial radio access (E-UTRA) is the radio interface of 3GPP's LTE upgrade path for UMTS mobile networks. In these systems, there are different frequencies where LTE (or E-UTRA) can be used, and in such systems, user mobile communications devices connect to a serving system, which is represented by a cell. In LTE, each cell is produced by a node called eNodeB (eNB). A gNodeB (gNB) is a node in a cellular network that provides connectivity between user equipment (UE) and the evolved packet core (EPC).

For example, FIG. 1 is an example of a wireless communications system (WCS) 100 that includes a radio node 102 configured to support one or more service providers SP₁-SP_{N}, 104(1)-104(N) as signal sources (also known as “carriers” or “service operators”—e.g., mobile network operator (MNO)) and wireless user devices 106(1)-106(D). For example, the radio node 102 may be a base station (e.g., eNodeB or gNodeB) that includes modem functionality and is configured to distribute. For example, the radio node 102 in the WCS 100 in FIG. 1 can be a small cell RAN (“small cell RAN”) that is configured to support multiple service providers 104(1)-104(N) by distributing a communications signal stream 108(1)-108(S) for the multiple service providers 104(1)-104(N) to the wireless client devices 106(1)-106(W) based on communications signals 110(1)-110(N) received from the service providers 104(1)-104(N). The communications signal streams 108(1)-108(S) of each respective service provider 104(1)-104(N) in their different spectrums are radiated through an antenna 112 to the wireless client devices 106(1)-106(W) in a communication range of the antenna 112 (e.g., a single antenna or an antenna array). As another example, the radio node 102 in the WCS 100 in FIG. 1 can be a small cell radio access node (“small cell”) that is configured to support the multiple service providers 104(1)-104(N) by distributing the communications signal streams 108(1)-108(S) for the multiple service providers 104(1)-104(N) based on respective communications signals 110(1)-110(N) received from a respective core network CN₁-CN_{N} of the service providers 104(1)-104(N) through interface connections.

The radio node 102 includes radio circuits 118(1)-118(N) for each service provider 104(1)-104(N) that are configured to create multiple simultaneous or non-simultaneous RF beams (“beams”) 120(1)-120(N) for the communications signal streams 108(1)-108(S) to serve multiple wireless client devices 106(1)-106(W). For example, the multiple RF beams 120(1)-120(N) may support beam based and/or massive multiple-input, multiple-output (mMIMO) communications. The distributed communications signal stream 108(1)-108(S) may be received from a base station (e.g., eNB or gNB) or respective evolved packet cores (EPC) network CN₁-CN_{N} of the service provider 104(1)-104(N) through interface connections. Small cells can support one or more service providers in different channels within a frequency band to avoid interference and reduced signal quality as a result. Secure communications tunnels are formed between the wireless user devices 106(1)-106(D) and the respective service provider 104(1)-104(N). Thus, in this example, the radio node 102 essentially appears as a single node (e.g., eNB in 4G or gNB in 5G) to the service provider 104(1)-104(N).

There is increasing demand for geo-location of user devices in in-building WCSs like the WCS 100 in FIG. 1. Emergency use cases and enhancing user experience both have strong use cases for geo-location of user devices.

### SUMMARY

Embodiments disclosed herein include determining the geo-location of user devices in a multi-radio distributed wireless communication system (WCS) using measured uplink power in radio units (RUs) on a per-user device basis. Related methods and computer-readable media are also disclosed. The multi-radio distributed WCS can be a radio access network (RAN), such as an Open-RAN (O-RAN) that is compatible with the Open-RAN standard set forth by the O-RAN Alliance as a non-limiting example. The multi-radio distributed WCS includes a base station coupled to distributed radio units (RUs) to provide a cell for subscriber user devices (e.g., cellular communication devices). The base station in the multi-radio distributed WCS can include a central unit (CU), a distribution unit (DU), and one or more radio units (RUs) as an example. The RU(s) can include the lowest layers of the base station and is the entity that wirelessly transmits and receives signals to and from user devices. The multi-radio distributed WCS has a radio aggregation unit between the RUs and the DU that distributes the same downlink signal from the DU to the RUs to be transmitted to user devices in communication with the RU(s), and aggregates (i.e. sums) upline signals received from multiple RUs that were transmitted by user devices. In exemplary aspects, to determine the geo-location of user devices in the multi-radio distributed WCS, uplink communication signals transmitted by user devices containing downlink signal strength information for received downlink signals transmitted by the RUs, can be received in multiple RUs. For example, multiple RUs in the multi-radio distributed WCS may be in the reception range of a user device transmitting an uplink communication signal. This downlink signal strength information in the uplink communication signals transmitted by multiple user devices can be used to determine the geo-location of a user device being within the multi-radio distributed WCS. However, the simultaneous transmission of uplink communication signals by multiple user devices received by RUs, along with the aggregation of these uplink communication signals that are then provided to the DU or other high-layer device in the multi-radio distributed WCS, does not allow distinguishing which user devices were responsible for which uplink communication signals received by the RUs.

In this regard, to avoid the issue of uplink communication signals transmitted by the user devices with downlink signal strength information being simultaneously received and aggregated such that the identity of the user devices with regard to downlink signal strength information is lost, the user devices are each configured to be scheduled to transmit an uplink reference signal at different scheduled times for the purposes of geo-location tracking. For example, the uplink reference signal may be a sounding reference signal (SRS) that is a reference signal transmitted by a user device in the uplink direction and used by the base station to estimate uplink channel quality. Multiple RUs that are in the transmission range of a given user device will each receive an uplink reference signal transmitted by the user device. The measured power in such received uplink reference signal, as well as its time of arrival (TOA) information in the multiple RUs can be used to determine the geo-location of the user device. In this regard, user devices that are identified as active user devices in the multi-radio distributed WCS are each configured to be scheduled to transmit an uplink reference signal at different times. This is so the uplink reference signal received by multiple RUs can be identified as being transmitted from a particular user device on a per-user device basis. The measured uplink power in each received uplink reference signal by each RU that was transmitted by a scheduled user device is used to create a user device report with the measured uplink power of the uplink reference signal received from the scheduled user device. The TOA of the uplink reference signal received by each RU is also determined and associated with the different measured uplink power of the uplink reference signal for each RU. In this manner, the user device report for a user device being analyzed by a processing circuit or other device (e.g. within the base station) based on differences in uplink power and differences in TOA of the uplink reference signal in RUs to determine the geo-location of the user devices relative to those RUs within the WCS. A user device report is generated for each scheduled user device based on the uplink power in the received uplink reference signal transmitted by the scheduled user device and received in multiple RUs and its TOA in such RUs.

In an exemplary aspect, as part of determining the geo-location of user devices in the multi-radio distributed WCS, the base station is configured to configure the user devices to transmit uplink SRSs as the uplink reference signal in wideband. An SRS signal has the flexibility to be configured for whole or partial bandwidth with or without combining. A DU in the WCS provides scheduling information for all active user devices in the multi-radio distributed WCS to transmit an uplink SRS at different times as part of a geo-location tracking function. Before any combining of the received uplink communication signals from the RUs is performed, each RU is configured to measure the SRS power of a received uplink SRS in the time domain that was transmitted by a scheduled user device. Since the user devices are scheduled to transmit uplink SRSs at different times, the measured SRS power in an uplink SRS received in a given RU can be correlated to a particular user device. The measured SRS power in each received uplink SRS by each RU from the scheduled user device is used to create a user device report that contains the different measured uplink powers of the uplink reference signal that were received in multiple RUs. The RUs can be configured to provide the measured uplink power of the received uplink SRS as a reference signal strength indicator (RSSI). A radio aggregation unit coupled to the RUs can be configured to receive the RSSI from each RU and provide such RSSIs before combining into a combined uplink communication signal to be used to generate a user device report that includes the RSSI of the received uplink SRS in multiple RUs for a given user device. The TOA of the uplink SRS is also provided in the user device report associated with each RU and its determined RSSI for the user device. The user device report created a given user device can then be analyzed by the processing circuit or other device (e.g., within the base station) to determine the geo-location of the user devices relative to multiple RUs within the WCS based on the difference in RSSIs and TOA of the uplink SRS received in the multiple RUs. The TOA information of the received uplink SRSs in the RUs can be determined even after combining of the uplink SRSs in radio aggregation unit received the multiple RUs and converted to the frequency domain (e.g. for decoding). SRS in the frequency domain correlates generally to an impulse signal, and thus an estimation of differences in TOAs of multiple SRSs from the multiple RUs can be performed by correlating the timing delay in such impulse/peak SRSs to differences in TOA in a time domain.

One exemplary embodiment of the disclosure relates to a wireless communications system (WCS). The WCS comprises a plurality of radio units (RUs), each having a cell coverage area, and each configured to transmit a downlink communication signal to a user device among a plurality of user devices in its cell coverage area, receive an uplink communication signal from the user device; and receive an uplink reference signal from the user device; and receive an uplink communication signal from the user device. The WCS is configured to schedule each of the plurality of user devices as a scheduled user device to transmit an uplink reference signal at different times. Each RU of the plurality of RUs is further configured to measure uplink power in the received uplink reference signal from the scheduled user device; and communicate the measured uplink power for the RU and the scheduled user device. The WCS is further configured to, for each scheduled user device of the plurality of user devices receive the measured uplink power for the scheduled user device from each RU of the plurality of RUs, correlate time of arrival (TOA) of the uplink reference signal received in each RU to the received measured uplink power for each RU; generate a user device report for the scheduled user device based on the received measured uplink power in the uplink reference signal for each RU and the TOA of the uplink reference signal for each RU; and determine geo-location of the plurality of user devices within the WCS based on the user device report for the plurality of user devices.

An additional exemplary embodiment of the disclosure relates to a method for determining geo-location of a plurality of user devices in a wireless communication system (WCS). The method comprises scheduling each of a plurality of user devices as a scheduled user device to transmit an uplink reference signal at different times. For each scheduled user device of the plurality of user devices, the method further comprises receiving an uplink reference signal from the scheduled user device, measuring uplink power in the received uplink reference signal from the scheduled user device in each RU of a plurality of radio units (RUs); receiving the measured uplink power for the scheduled user device from each RU of the plurality of RUs; and correlating time of arrival (TOA) of the uplink reference signal received in each RU to the received measured uplink power for each RU, generating a user device report for the scheduled user device based on the received measured uplink power in the uplink reference signal for each RU and the TOA of the uplink reference signal for each RU, and determining geo-location of the plurality of user devices within the WCS based on the user device report for the plurality of user devices.

Additional features and advantages will be set forth in the detailed description that follows and, in part, will be readily apparent to those skilled in the art from the description or recognized by practicing the embodiments as described in the written description and claims hereof, as well as the appended drawings.

It is to be understood that both the foregoing general description and the following detailed description are merely exemplary and are intended to provide an overview or framework to understand the nature and character of the claims.

The accompanying drawings are included to provide a further understanding and are incorporated in and constitute a part of this specification. The drawings illustrate one or more embodiment(s), and, together with the description, serve to explain the principles and operation of the various embodiments.

### BRIEF DESCRIPTION OF THE DRAWINGS

FIG. 1 is a schematic diagram of an exemplary wireless communications system (WCS), such as a distributed communications system (DCS), configured to distribute communications services to remote coverage areas;

FIG. 2 is an exemplary multi-radio WCS in the form of an exemplary radio access network (RAN) that is configured to support a plurality of radio units (RUs) providing a cell to service user devices as subscriber devices in the communication range of the RU(s);

FIG. 3 is a schematic diagram of another multi-radio WCS similar to the RAN in FIG. 2, but wherein the multi-radio WCS is configured to determine the geo-location of active user devices in the multi-radio WCS based on a user device report created for each user device that indicates the uplink power in a received uplink reference signal in each of the RUs as a result of a scheduled user device transmitting an uplink reference signal, and time-of-arrival (TOA) information regarding the received uplink reference signal in each of the RUs;

FIG. 4 is a graph illustrating uplink power in a received uplink reference signal in multiple RUs in the multi-radio WCS as a result of a scheduled user device transmitting an uplink reference signal;

FIG. 5 is a schematic diagram illustrating three exemplary RUs in the multi-radio WCS in FIG. 3 each receiving an uplink reference signal transmitted by a scheduled user device;

FIG. 6 is a flowchart illustrating an exemplary process of the multi-radio WCS in FIG. 3 generating a user device report that indicates the uplink power in a received uplink reference signal in each of the RUs as a result of a scheduled user device transmitting an uplink reference signal and TOA information regarding the received uplink reference signal in each of the RUs to determine a geo-location of the user device within the multi-radio WCS;

FIG. 7 is a flowchart illustrating an exemplary process of the multi-radio WCS in FIG. 3 determining the geo-location of active user devices in the multi-radio WCS based on a user device report created for each user device that indicates the uplink power in a received uplink reference signal in each of the RUs as a result of a scheduled user device transmitting an uplink reference signal and TOA information regarding the received uplink reference signal in each of the RUs;

FIG. 8 is a flowchart illustrating an exemplary process of the multi-radio WCS in FIG. 3 analyzing a user device report generated by the DU as part of the process in FIG. 5 to determine the geo-location of an active user device in the multi-radio WCS in FIG. 3;

FIG. 9 is a schematic diagram of another exemplary multi-radio WCS, including but not limited to the multi-radio WCS of FIG. 3, wherein the multi-radio WCS is configured to determine the geo-location of active user devices in the multi-radio WCS based on a user device report created for each user device that indicates the uplink power in a received uplink reference signal in each of the RUs as a result of a scheduled user device transmitting an uplink reference signal;

FIG. 10 is a partial schematic cut-away diagram of an exemplary building infrastructure that includes a multi-radio WCS, including but not limited to the multi-radio WCS of FIG. 3, wherein the multi-radio WCS is configured to determine the geo-location of active user devices in the multi-radio WCS based on a user device report created for each user device that indicates the uplink power in a received uplink reference signal in each of the RUs as a result of a scheduled user device transmitting an uplink reference signal;

FIG. 11 is a schematic diagram of an exemplary mobile telecommunications environment that includes a multi-radio WCS, including but not limited to the multi-radio WCS of FIG. 3, wherein the multi-radio WCS is configured to determine the geo-location of active user devices in the multi-radio WCS based on a user device report created for each user device that indicates the uplink power in a received uplink reference signal in each of the RUs as a result of a scheduled user device transmitting an uplink reference signal; and

FIG. 12 is a schematic diagram of a representation of an exemplary computer system that can be included in or interfaced with any of the components in a multi-radio WCS, including but not limited to the multi-radio WCS of FIG. 3, wherein the multi-radio WCS is configured to determine the geo-location of active user devices in the multi-radio WCS based on a user device report created for each user device that indicates the uplink power in a received uplink reference signal in each of the RUs as a result of a scheduled user device transmitting an uplink reference signal.

### DETAILED DESCRIPTION

Embodiments disclosed herein include determining geo-location of user devices in a multi-radio distributed wireless communication system (WCS) using measured uplink power in radio units (RUs) on a per user device basis. Related methods and computer-readable media are also disclosed. The multi-radio distributed WCS can be a radio access network (RAN), such as an Open-RAN (O-RAN) that is compatible with the Open-RAN standard set forth by the O-RAN Alliance as a non-limiting example. The multi-radio distributed WCS includes a base station coupled to distributed radio units (RUs) to provide a cell for subscriber user devices (e.g., cellular communication devices). The base station in the multi-radio distributed WCS can include a central unit (CU), a distribution unit (DU), and one or more radio units (RUs), as an example. The RU(s) can include the lowest layers of the base station and is the entity that wirelessly transmits and receives signals to and from user devices. The multi-radio distributed WCS has a radio aggregation unit between the RUs and the DU that distributes the same downlink signal from the DU to the RUs to be transmitted to user devices in communication with the RU(s), and aggregates (i.e. sums) upline signals received from multiple RUs that were transmitted by user devices. In exemplary aspects, to determine the geo-location of user devices in the multi-radio distributed WCS, uplink communication signals transmitted by user devices containing downlink signal strength information for received downlink signals transmitted by the RUs, can be received in multiple RUs. For example, multiple RUs in the multi-radio distributed WCS may be in the reception range of a user device transmitting an uplink communication signal. This downlink signal strength information in the uplink communication signals transmitted by multiple user devices can be used to determine the geo-location of a user device being within the multi-radio distributed WCS. However, the simultaneous transmission of uplink communication signals by multiple user devices received by RUs, along with the aggregation of these uplink communication signals that are then provided to the DU or other high-layer device in the multi-radio distributed WCS, does not allow distinguishing which user devices were responsible for which uplink communication signals received by the RUs.

In this regard, this regard, to avoid the issue of uplink communication signals transmitted by the user devices with downlink signal strength information being simultaneously received and aggregated such that the identity of the user devices with regard to downlink signal strength information is lost, the user devices are each configured to be scheduled to transmit an uplink reference signal at different scheduled times for the purposes of geo-location tracking. For example, the uplink reference signal may be a sounding reference signal (SRS) that is a reference signal transmitted by a user device in the uplink direction and used by the base station to estimate uplink channel quality. Multiple RUs that are in the transmission range of a given user device will each receive an uplink reference signal transmitted by the user device. The measured power in such received uplink reference signal as well as its time of arrival (TOA) information in the multiple RUs, can be used to determine the geo-location of the user device. In this regard, user devices that are identified as active user devices in the multi-radio distributed WCS are each configured to be scheduled to transmit an uplink reference signal at different times. This is so the uplink reference signal received by multiple RUs can be identified as being transmitted from a particular user device on a per-user device basis. The measured uplink power in each received uplink reference signal by each RU that was transmitted by a scheduled user device is used to create a user device report with measured uplink power of the uplink reference signal received from the scheduled user device. The TOA of the uplink reference signal received by each RU is also determined and associated with the different measured uplink power of the uplink reference signal for each RU. In this manner, the user device report for a user device being analyzed by a processing circuit or other device (e.g. within the base station) based on differences in uplink power and differences in TOA of the uplink reference signal in RUs to determine the geo-location of the user devices relative to those RUs within the WCS. A user device report is generated for each scheduled user device based on the uplink power in the received uplink reference signal transmitted by the scheduled user device and received in multiple RUs and its TOA in such RUs.

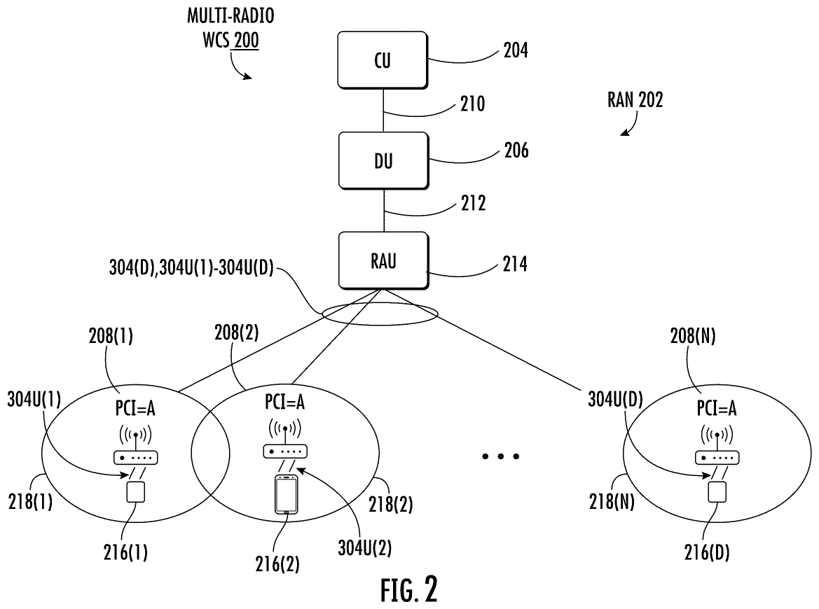

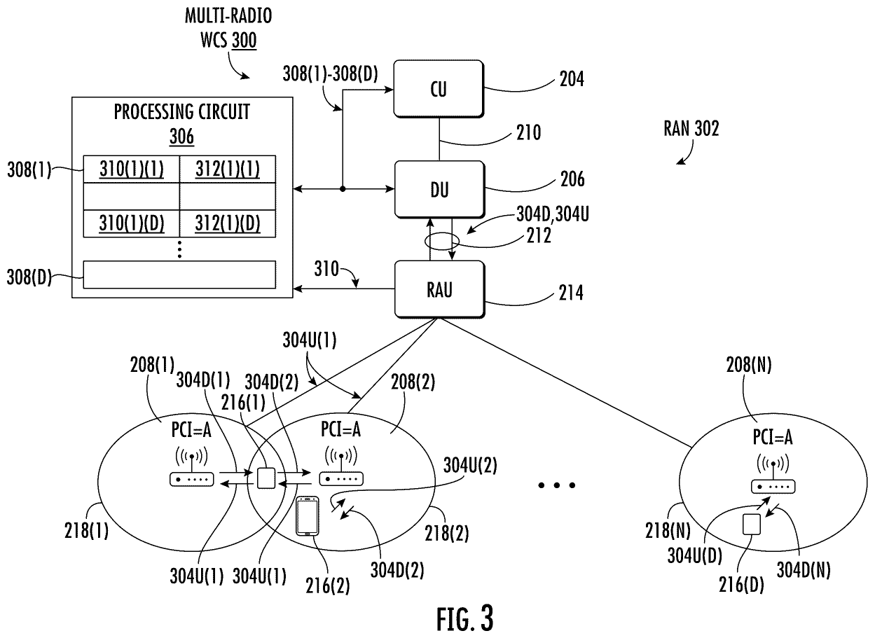

Before discussing examples of multi-radio WCSs that are configured to determine the geo-location of user devices within the multi-radio WCSs using measured uplink power in radio units (RUs) on a per-user device basis starting at FIG. 3, an example of multi-radio WCSs that is not so configured is first discussed below with regard to FIG. 2.

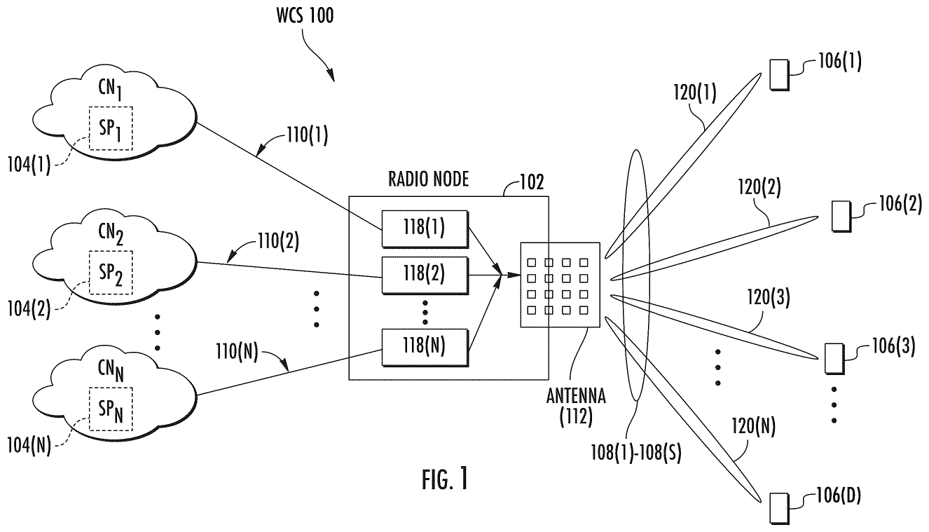

Radio nodes, like radio node 102 in FIG. 1, can be included as part of a multi-radio WCS, which may be a radio access network (RAN). For example, one type of RAN is Open-RAN (O-RAN), which is a RAN that is compatible with a set of specifications that specifies multiple options for functional divisions of a cellular base station between physical units, and it also specifies the interface between these units. An example of a multi-radio WCS 200, which is RAN 202, is shown in FIG. 2. In the multi-radio WCS 200, the functionality of the base station (e.g., gNB, as called in the context of 5G) is divided into three functional units of a central unit (CU) 204, a distribution unit (DU) 206 and one or more remote nodes, also called radio units (RUs) 208(1)-208(N) to provide a cell for cell service ‘A,’ where ‘N’ can represent any number of RUs. These components may run on different hardware platforms and reside at different locations. The RUs 208(1)-208(N) include the lowest layers of the base station, and it is the entity that wirelessly transmits and receives signals to user devices 216(1)-216(D) in the communication range of a given RU 208(1)-208(N). The CU 204 includes the highest layers of the base station and is coupled to a “core network” of the cellular service provider. The DU 206 includes the middle layers of the base station to provide support for a single cellular service provider (also known as operator or carrier). An F1 interface 210 is connected between the CU 204 and the DU 206. An eCPRI fronthaul interface 212 connects the DU 206 and the RUs 208(1)-208(N).

The DU 206 is coupled to a cluster of RUs 208(1)-208(N) that serve a cell ‘A’ of the DU 206. A “cell” in this context is a set of signals intended to serve subscriber units (e.g., cellular devices) in a certain area. The multiple RUs 208(1)-208(N) are supported in the RAN 202 by what is referred to as “Shared-Cell” by a radio aggregation unit 214 (e.g., a front-haul multiplexer (FHM)) placed between the DU 206 and the RUs 208(1)-208(N). The radio aggregation unit 214 de-multiplexes (i.e. de-aggregates) downlink communication signals 304D from the DU 206 and split by the radio aggregation unit 214 to be distributed as downlink communication signals 30x4D(1)-304D(N) to the RUs 208(1)-208(N). The downlink communication signals 304D(1)-304D(N) are communicated to respective user devices 216(1)-216(D) in communication range within a respective cell coverage area 218(1)-218(N) of a given RU 208(1)-208(N) and multiplexes (i.e., aggregates or sums) uplink communication signals transmitted by the user devices 216(1)-216(D) to a RU(s) 208(1)-208(N), which are then distributed from the RUs 208(1)-208(N) to DU 206 and CU 204. The radio aggregation unit 214 can be considered as a RU with front haul support and additional copy-and-combine function but lacks the RF front-end capability. The radio aggregation unit 214 multiplexes (i.e., sums) the uplink communication signals received from each of the RUs 208(1)-208(N) as part of the same cell to provide to the DU 206.

There is increasing demand for geo-location of user devices in in-building RANs. Emergency use cases and enhancing user experience both have strong use cases for the geo-location of user devices. For example, in the multi-radio WCS 200 in FIG. 2, determining the geo-location of a user device 216(1)-216(D) can be performed using reference signal received power (RSRP). RSRP is a type of received strength signal indicator (RSSI) measurement by a user device 216(1)-216(D) indicative of the received power of a reference signal (RS) mapped to a resource element (RE). The user devices 216(1)-216(D) are configured to measure all the REs that carry an RS. The RSPP is an average of power levels received by a user device 216(1)-216(D) across all RS symbols within a considered measured frequency bandwidth. The user devices 216(1)-216(D) can report their RSRPs through the RUs 208(1)-208(N), which are then aggregated by the radio aggregation unit 214 and provided as time-domain uplink communication signals to the DU 206 and CU 204 as part of the cell and associated with a physical cell identification (ID) of the cell. The CU 204 can use the received reported RSRPs for a cell(s) to model/estimate of distance of the user devices 216(1)-216(D) with respect to different nearby cells as part of geo-locating the user devices 216(1)-216(D). However, in the multi-radio WCS 200 in FIG. 2, because the RUs 208(1)-208(N) are each transmitting the same downlink signal, the user devices 216(1)-216(D) are not able to differentiate between the downlink signals from the different RUs 208(1)-208(N). Thus, a technique whereby different downlink signals are used to be received by the RUs 208(1)-208(N) and transmitted to the user devices 216(1)-216(D) to measure RSRP cannot be differentiated as there is only a single cell with the same downlink signal transmitted by the RUs 208(1)-208(N). The RSRP reports communicated in uplink communication signals by multiple user devices 216(1)-216(D) simultaneously through their respective connected RUs 208(1)-208(N) are aggregated or combined by the radio aggregation unit 214 before these RSRP reports can be processed in higher layers in the DU 206 and/or the CU 204. This makes it not possible to differentiate differences in RSRP reports to specific RUs 208(1)-208(N) in the cell.

In this regard, FIG. 3 is a schematic diagram of another multi-radio WCS 300 that is provided in the form of a RAN 302 and is similar to the multi-radio WCS 200 that is in FIG. 2. Common elements between the multi-radio WCS 200 in FIG. 2 and the multi-radio WCS 300 in FIG. 3 are shown with common element numbers. However, as discussed in more detail below, unlike the multi-radio WCS 200 in FIG. 2, the multi-radio WCS 300 is configured to determine the geo-location of active user devices 216(1)-216(D) in the multi-radio WCS 300 based on a user device report created for each user device 216(1)-216(D) that indicates the uplink power in a received uplink reference signal in multiple RUs 208(1)-208(N) and its TOA in the multiple RUs 208(1)-208(N). The received uplink reference signal from each user device 216(1)-216(D) is part of the respective uplink communication signal 304U(1)-304U(D) transmitted by the respective user devices 216(1)-216(D). For example, as shown in FIG. 3, the user device 216(1) is in multiple cell coverage areas 218(1), 218(2) of the respective RUs 208(1), 208(2). Thus, each RU 208(1), 208(2) will receive the uplink communication signal 304U(1) transmitted by the user device 216(1). As discussed below, the uplink communication signal 304U(1) can be an uplink reference signal 304U(1) that includes downlink communication signal 304D(1) signal strength as determined from the user device 216(1).

The relative location of the user device 216(1) to the respective RUs 208(1), 208(2) will control the signal strength (i.e., power in) in the received uplink communication signal at each of the RUs 208(1), 208(2). The uplink communication signal 304U(1) is a result of each scheduled user device 216(1)-216(D) among the plurality of user devices 216(1)-216(D) transmitting an uplink reference signal that is received by one or more RUs 208(1)-208(N). TOA information regarding the received uplink communication signal 304U(1)-304U(D) transmitted by a scheduled user device 216(1)-216(D) in combination with the respective differences in measured power in the received uplink communication signal 304U(1)-304U(N) received in the RUs 208(1)-208(N) can be used to determine the geo-location of the scheduled user device 216(1)-216(D) within the multi-radio WCS 300. However, using the example of the user device 216(1), the aggregation of the uplink communication signal 304U(1) received in the RUs 208(1), 208(2) by the radio aggregation unit 214, does not allow distinguishing from which RUs 208(1), 208(2), the uplink communication signals 304U(1) was received and at what power level, and thus where a geo-location of user device 216(1)-216(D) with respect to the RU(s) 208(1)-208(N) receiving such uplink communication signals 304U(1)-304U(D).

In this regard, with respect to the example of the user device 216(1) shown in FIG. 3, to avoid the issue of such uplink communication signals 304U(1) transmitted by the user device 216(1) being aggregated such that the uniqueness of which RU 208(1), 208(2) received distributed such uplink communication signal at a given power level is lost, the user device 216(1) is configured to transmit an uplink reference signal 304U(1) as a uplink communication signal 304U(1) according to a scheduled time. For example, the uplink reference signal 304U(1) may be a sounding reference signal (SRS) that is a reference signal transmitted by the user device 216(1) in the uplink direction and used by the multi-radio WCS 300 to estimate uplink channel quality. The RUs 208(1), 208(2) that receive the uplink reference signal 304U(1) transmitted by the user device 216(1) are configured to measure the uplink power of the received uplink reference signal 304U(1) transmitted by the user device 216(1) in the time domain. The RUs 208(1), 208(2) are configured to provide the measured uplink power as a reference signal indicator (RSSI) in this example to the radio aggregation unit 214. The radio aggregation unit 214 is configured to convert the uplink reference signal 304U(1) received from the multiple RUs 208(1), 208(2) into the frequency domain to decoded the uplink reference signal 304U(1) for processing. Thus, in this example, the radio aggregation unit 214 provides the RSSI information for the user device 216(1) before such conversion and combing of the uplink reference signal 304U(1) from the multiple RUs 208(1), 208(2) into a combined uplink reference signal 304U. The measured uplink power of a received uplink reference signal 304U(1) in the RUs 208(1), 208(2) as RSSIs is provided to the radio aggregation unit 214 in a time domain and used to create a user device report for the user device 216(1) before any combining of uplink communication signals 304U(1)-304U(D) into a combined uplink communication signal 304U. In this example, the radio aggregation unit 214 is configured to provide the measured uplink power 310 in the received uplink reference signal 304U(1) from the multiple RUs 208(1), 208(2) to a processing circuit 306. The processing circuit 306 is shown as a separate circuit, but such could be provided within the DU 206 as an example. The processing circuit 306 is configured to generate a user device report 308(1) for the user device 216(1) that includes the measured uplink power 310(1)(1)-310(1)(D) in the received uplink reference signal 304U(1) from the multiple RUs 208(1)-208(D).

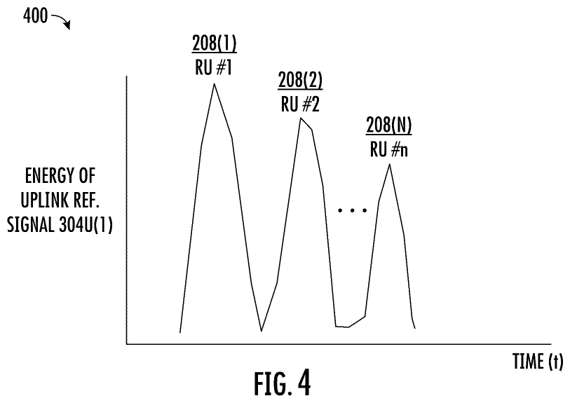

In this example, the DU 206 is configured to provide the TOA 312(1)(1)-312(1)(D) for the uplink reference signal 304U(1) as received in the multiple RUs 208(1)-208(N) in the user device report 308(1) for the user device 216(1). For example, the processing circuit 306 could provide the user device report 308(1) for the user device 216(1) to the DU 206 if the processing circuit 306 is not part of the DU 206. The DU 206 receives the combined uplink communication signal 304U from the radio aggregation unit 214 that has the combined uplink reference signals 304U(1) received from the multiple RUs 208(1), 208(2) that each received the uplink reference signal 304U(1) from the user device 216(1). As discussed above, the radio aggregation unit 214 is configured to convert the uplink reference signal 304U(1) received from the multiple RUs 208(1), 208(2) into the frequency domain to decoded the uplink reference signal 304U(1) for processing. However, in this example, because the user device 216(1) was configured to transmit the uplink reference signal as a wideband SRS, the combined uplink reference signal 304U will more readily capture delay spread of received uplink reference signal 304U(1) that was transmitted by the user device 216(1) and received by the multiple RUs 208(1), 208(2) and provided as separate uplink reference signals 304U(1) to the radio aggregation unit 214. For example, SRS in the frequency domain correlates generally to an impulse signal, and thus an estimation of differences in TOAs of multiple SRSs as uplink reference signals 304U(1)-304U(D) from the multiple RUs 208(1)-208(N) can be performed by correlating the delay spread in such uplink reference signals 304U(1)-304U(D) to differences in TOA in a time domain. This is shown in the exemplary graph 400 illustrating measured uplink energy (power) on the Y-axis of received uplink reference signal 304U(1) transmitted by the user device 216(1) in FIG. 3 in multiple RUs 208(1)-208(N) (X-axis) plotted against time (t). As shown in FIG. 4, even though the combined uplink reference signal 304U is received in the DU 206 in the frequency domain, the different in arrival of the uplink reference signal 304U(1) in the multiple RUs 208(1)-208(N) that are then converted into the frequency domain by the radio aggregation unit 214 and provided to the DU 206 as received can be plotted in the time domain and correlated to a particular RUs 208(1)-208(N) based on the difference in RSSI of the uplink reference signal 304U(1) received in RU 208(1)-208(N). In this manner, TOA 312(1)(1)-312(1)(D) for each uplink reference signal 304U(1) received in RU 208(1)-208(N) can also be captured and associated with a particular RU 208(1)-208(N) and the recorded RSSI for the uplink reference signal 304U(1) received in respective RU 208(1)-208(N).

In this manner, the user device report 308(1) for the user device 216(1) includes information about the measured uplink power of the uplink reference signal 304U(1) received in each RU 208(1)-208(N) and their different TOAs of the uplink reference signal 304U(1) received in RU 208(1)-208(N). This user device report 308(1) can then be analyzed, such as by the DU 206 or CU 204, or other device in the multi-radio WCS 300, and using the uplink power and TOA information of the uplink reference signal 304U(1) in the multiple RUs 208(1)-208(N) to determine the geo-location of the user device 216(1) relative to RUs 208(1), 208(2).

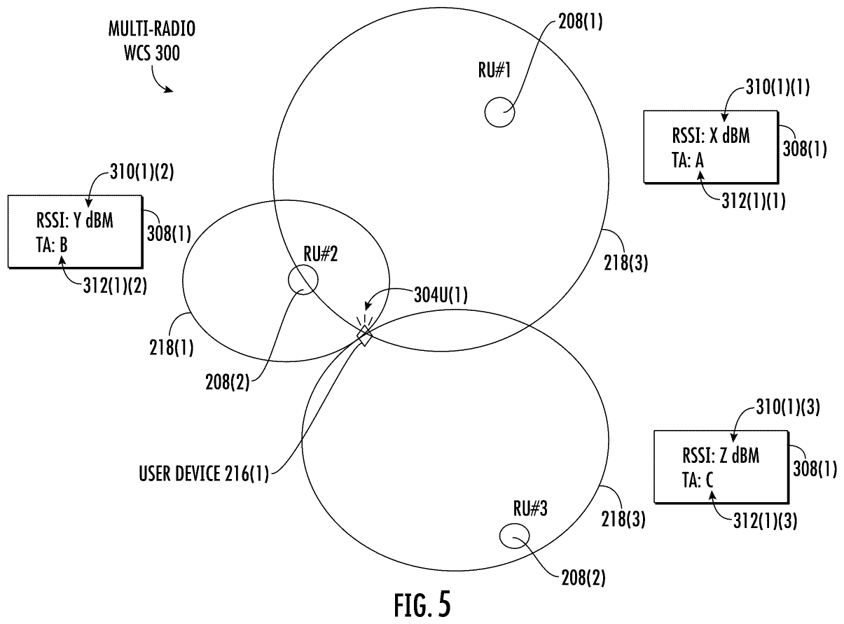

FIG. 5 is a schematic diagram illustrating another example of determining a geo-location of the user device 216(1) in the multi-radio WCS 300 in FIG. 3 relative to three (3) exemplary RUs 208(1)-208(3). As shown in FIG. 5, the user device 216(1) is within the cell coverage areas 218(1)-218(3) of each of the three (3) RUs 208(1)-208(3). Thus, each of the RUs 208(1)-208(3) receive an uplink reference signal 304U(1) transmitted by the user device 216(1) in their respective cell coverage areas 218(1)-218(3) with varying signal power levels and TOA. As shown in FIG. 5, the user device report 308(1) includes a difference of TOAs 312(1)(1)-312(1)(3) of A, B, C of the uplink reference signal 304U(1) received by the respective RUs 208(1)-208(3) at respective measured uplink power 310(1)(1)-310(1)(3) of X, Y, and Z dBMs. This information is used to generate the user device report 308(1) for the user device 216(1), which can be used to determine the geo-location of the user device 216(1) relative to the three (3) RUs 208(1)-208(3). As shown in FIG. 5, the user device 216(1) is located at a particular intersection point of the three (3) cell coverage areas 218(1)-218(3) of the three (3) RUs 208(1)-208(3) that can be determined on the difference of TOAs A, B, C of the uplink reference signal 304U(1) received by the respective RUs 208(1)-208(3) at respective signal strengths X, Y, and Z dBMs.

Note that the above example is described with regard to a single user device 216(1), but the same functionality is provided among each of the active user devices 216(1)-216(D) in the multi-radio WCS 300. However, to avoid RUs 208(1)-208(N) receiving uplink communication signals 304U(1)-304U(D) from multiple user devices 216(1)-216(D) at the same time and making it difficult or not possible to distinguish power levels of received uplink communication signals 304U(1)-304U(D) relative to user devices 216(1)-216(D), the multi-radio WCS 300 is also configured to schedule the user devices 216(1)-216(D) to transmit their uplink reference signals 304U(1)-304U(D) at different times, so that the uplink power in the uplink reference signals 304U(1)-304U(D) received by multiple RUs 208(1)-208(N) from a particular user device 216(1)-216(D) can be analyzed on a per-user device 216(1)-216(D) basis. The user device reports 308(1)-308(D) can each include multiple respective measured uplink powers 310(1)(1)-310(1)(D)-310(N)(1)-310(N)(D) for each RU 208(1)-208(N) and correlating multiple TOAs 312(1)(1)-312(1)(D)-312(N)(1)-312(N)(D).

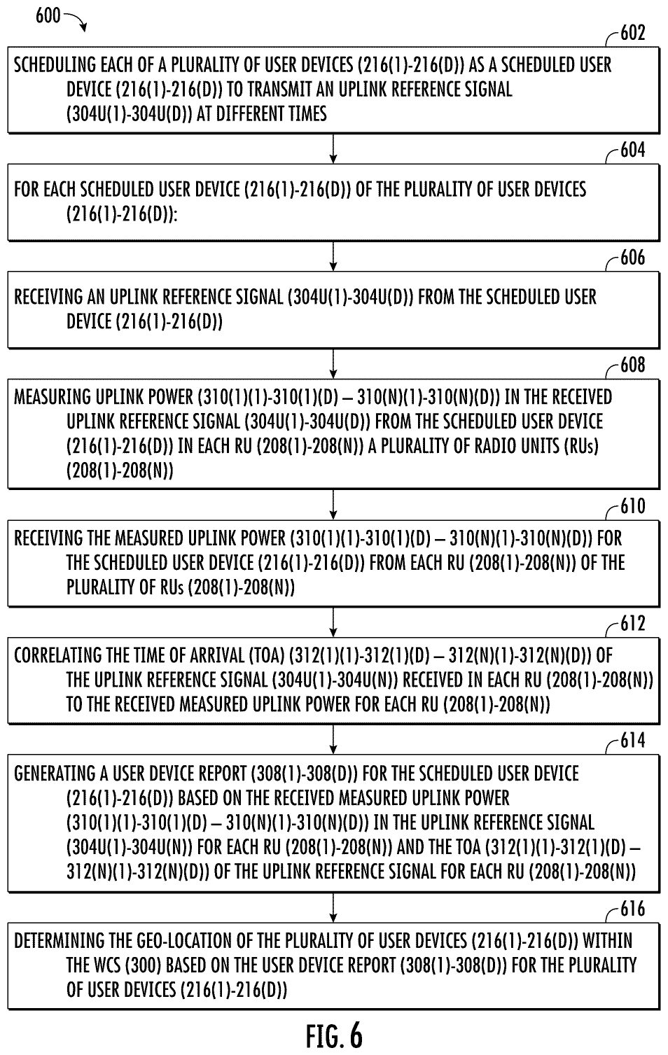

FIG. 6 is a flowchart illustrating an exemplary process 600 of the multi-radio WCS 300 in FIG. 3 generating a user device report 308(1)-308(D) that indicates the uplink power 310(1)(1)-310(1)(D)-310(N)(1)-310(N)(D) in a received uplink reference signal 304U(1)-304U(D) in each of the RUs 208(1)-208(N) as a result of a respective scheduled user device 216(1)-216(D) transmitting the uplink reference signal 304U(1)-304U(D) and TOA information regarding the received uplink reference signal 304U(1)-304U(D) in each of the RUs 208(1)-208(N) to determine a geo-location of the user device 216(1)-216(D) within the multi-radio WCS 300.

In this regard, as shown in FIG. 6, a first step of the process 600 can be to schedule each of a plurality of user devices 216(1)-216(D) as a scheduled user device 216(1)-216(D) to transmit the respective uplink reference signal 304U(1)-304U(D) at different times (block 602 in FIG. 6). A next step in the process 600 can be for each scheduled user device 216(1)-216(D) of the plurality of user devices 216(1)-216(D) (block 604 in FIG. 6), receiving an uplink reference signal 304U(1)-304U(D) from the scheduled user device 216(1)-216(D) (block 606 in FIG. 6). A next step in the process 600 can also be for each scheduled user device 216(1)-216(D) of the plurality of user devices 216(1)-216(D) (block 604 in FIG. 6), measuring uplink power 310(1)(1)-310(1)(D)-310(N)(1)-310(N)(D) in the received uplink reference signal 304U(1)-304U(D) from the scheduled user device 216(1)-216(D) in a plurality of RUs 208(1)-208(N) (block 608 in FIG. 6). A next step in the process 600 can also be for each scheduled user device 216(1)-216(D) of the plurality of user devices 216(1)-216(D) (block 604 in FIG. 6), receiving the measured uplink power 310(1)(1)-310(1)(D)-310(N)(1)-310(N)(D) for the scheduled user device 216(1)-216(D) from each RU 208(1)-208(N) of the plurality of RUs 208(1)-208(N) (block 610 in FIG. 6). A next step in the process 600 can also be for each scheduled user device 216(1)-216(D) of the plurality of user devices 216(1)-216(D) (block 604 in FIG. 6), correlating the TOA 312(1)(1)-312(1)(D)-312(N)(1)-312(N)(D) of the uplink reference signal 304U(1)-304U(N) received in each RU 208(1)-208(N) to the received measured uplink power for each RU 208(1)-208(N) (block 612 in FIG. 6). A next step in the process 600 can also be for each scheduled user device 216(1)-216(D) of the plurality of user devices 216(1)-216(D) (block 604 in FIG. 6), generating a user device report 308(1)-308(D) for the scheduled user device 216(1)-216(D) based on the received measured uplink power 310(1)(1)-310(1)(D)-310(N)(1)-310(N)(D) in the uplink reference signal 304U(1)-304U(N) for each RU 208(1)-208(N) and the TOA 312(1)(1)-312(1)(D)-312(N)(1)-312(N)(D) of the uplink reference signal for each RU 208(1)-208(N) (block 614 in FIG. 6). A next step in the process 600 can also be for each scheduled user device 216(1)-216(D) of the plurality of user devices 216(1)-216(D) (block 604 in FIG. 6), determining the geo-location of the plurality of user devices 216(1)-216(D) within the multi-radio WCS 300 based on the user device report 308(1)-308(D) for the plurality of user devices 216(1)-216(D) (block 616 in FIG. 6).

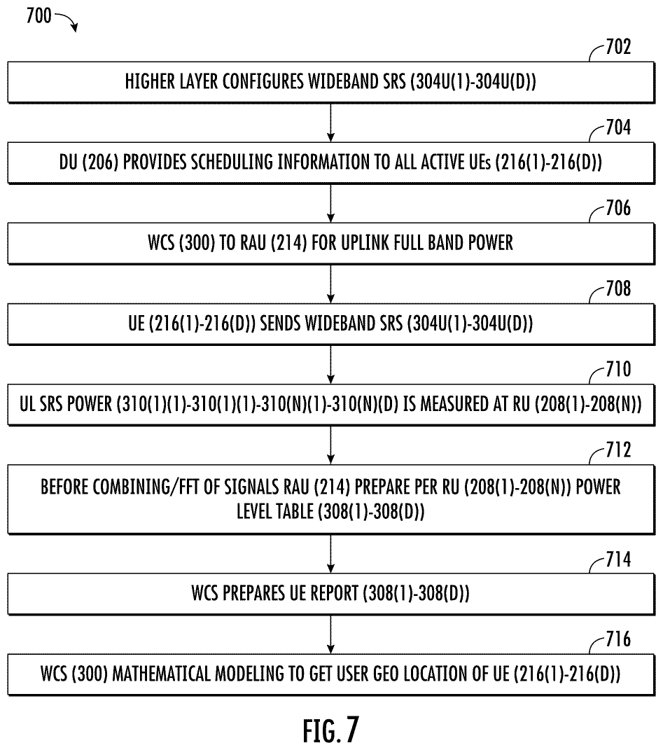

FIG. 7 is a flowchart illustrating another exemplary process 700 of the multi-radio WCS 300 in FIG. 3 generating a user device report 308(1)-308(D) that indicates the uplink power 310(1)(1)-310(1)(D)-310(N)(1)-310(N)(D) in a received uplink reference signal 304U(1)-304U(D) in each of the RUs 208(1)-208(N) as a result of a respective scheduled user device 216(1)-216(D) transmitting the uplink reference signal 304U(1)-304U(D) and TOA information regarding the received uplink reference signal 304U(1)-304U(D) in each of the RUs 208(1)-208(N) to determine a geo-location of the user device 216(1)-216(D) within the multi-radio WCS 300.

In this regard, as shown in FIG. 7, a first step in the process 700 is for the multi-radio WCS 300 to configured wideband uplink SRS transmission in the user devices 216(1)-216(D) (block 702 in FIG. 7). A next step in the process 700 is the DU 206 providing the scheduling information to the active user devices 216(1)-216(D) to control when they will transmit their respective uplink SRS 304U(1)-304U(D) (block 704 in FIG. 7). A next step in the process 700 is the multi-radio WCS 300 configuring the radio aggregation unit 214 for uplink full band power to be able to process received uplink SRS 304U(1)-304U(D) in wide band (block 706 in FIG. 7). A next step in the process 700 is the user devices 216(1)-216(D) transmitting a respective uplink SRS 304U(1)-304U(D) at their scheduled time to be received by RUs 208(1)-208(N) in their transmission range (block 708 in FIG. 7). A next step in the process 700 is the RUs 208(1)-208(N) measuring the uplink power 310(1)(1)-310(1)(D)-310(N)(1)-310(N)(D) in a received uplink SRS 304U(1)-304U(D) from a user device 216(1)-216(N) (block 710 in FIG. 7). Then, a next step in the process 700 is before the combining of the respective uplink SRS 304U(1)-304U(D) from multiple RUs 208(1)-208(N), provide RSSI of the measured uplink power 310(1)(1)-310(1)(D)-310(N)(1)-310(N)(D) in a respective received uplink SRSs 304U(1)-304U(D) from the RUs 208(1)-208(N) to be included in a respective user device report 308(1)-308(D) (block 712 in FIG. 7). A next step in the process 700 is the multi-radio WCS 300 to then prepare the respective user device reports 308(1)-308(D) based also on the TOA 312(1)(1)-312(1)(D)-312(N)(1)-312(N)(D) (block 714 in FIG. 7). A next step in the process 700 is the multi-radio WCS 300 using mathematical modeling of the user device reports 308(1)-308(D) to determine the geo-location of the user devices 216(1)-216(N) in the multi-radio WCS 300 (block 716 in FIG. 7).

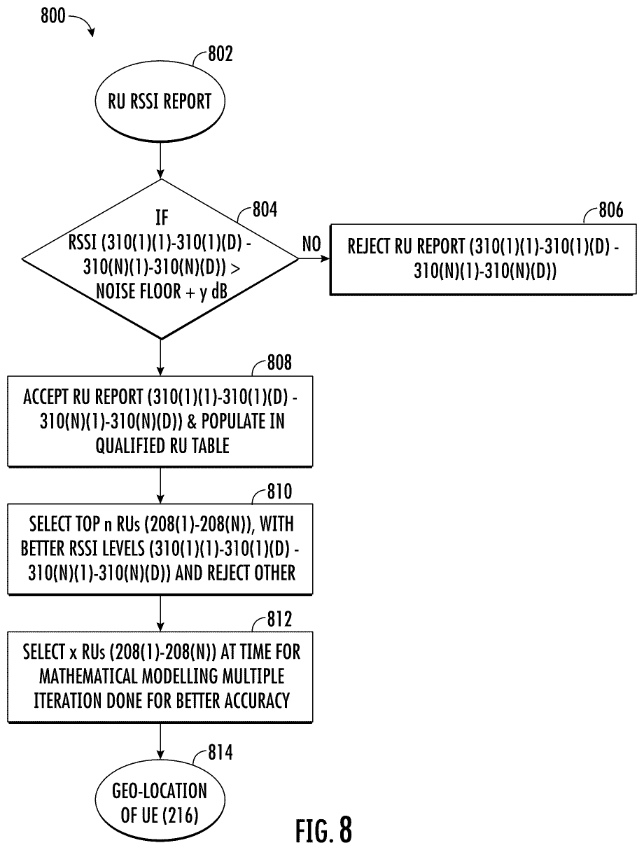

FIG. 8 is a flowchart illustrating another exemplary process 800 of the multi-radio WCS 300 in FIG. 3 generating a user device report 308(1)-308(D) that indicates the uplink power 310(1)(1)-310(1)(D)-310(N)(1)-310(N)(D) in a received uplink reference signal 304U(1)-304U(D) in each of the RUs 208(1)-208(N) as a result of a respective scheduled user device 216(1)-216(D) transmitting the uplink reference signal 304U(1)-304U(D) and TOA information regarding the received uplink reference signal 304U(1)-304U(D) in each of the RUs 208(1)-208(N) to determine a geo-location of the user device 216(1)-216(D) within the multi-radio WCS 300. The process 800 can be part of the processes 600, 700 in FIGS. 6 and 7 as examples.

In this regard, as shown in FIG. 8, a first step in the process 800 is for the processing circuit 306 and/or DU 206 to receive an uplink power 310(1)(1)-310(1)(D)-310(N)(1)-310(N)(D) of a respective uplink reference signal 304U(1)-304U(D) from a respective RU 208(1)-208(N) transmitted by a respective user device 216(1)-216(D) (block 802 in FIG. 8). A next step in the process 800 is for the processing circuit 306 and/or DU 206 to determine if the uplink power 310(1)(1)-310(1)(D)-310(N)(1)-310(N)(D) of a respective uplink reference signal 304U(1)-304U(D) from a respective RU 208(1)-208(N) exceeds a defined noise threshold of X dB (block 804 in FIG. 8). This is so that a user device report 308(1)-308(D) for a respective user device 216(1)-216(D) is not recorded with uplink powers (e.g., RSSIs) that are considered noise and thus are not a true indication that a respective RU 208(1)-208(N) received a respective uplink reference signal 304U(1)-304U(D) transmitted by a respective user device 216(1)-216(D). If the processing circuit 306 and/or DU 206 determine uplink power 310(1)(1)-310(1)(D)-310(N)(1)-310(N)(D) of a respective uplink reference signal 304U(1)-304U(D) from a respective RU 208(1)-208(N) does not exceed the defined noise threshold of X dB (block 804 in FIG. 8), the report of the uplink power 310(1)(1)-310(1)(D)-310(N)(1)-310(N)(D) from the respective RU 208(1)-208(N) is rejected and not included in a respective user device report 308(1)-308(D) for the user device 216(1)-216(D) that was scheduled to transmit the uplink reference signal 304U(1)-304U(D) (block 806 in FIG. 8).

However, if the processing circuit 306 and/or DU 206 determine uplink power 310(1)(1)-310(1)(D)-310(N)(1)-310(N)(D) of a respective uplink reference signal 304U(1)-304U(D) from a respective RU 208(1)-208(N) does exceed the defined noise threshold of X dB (block 804 in FIG. 8), then the processing circuit 306 and/or DU 206 accepts the report of the uplink power 310(1)(1)-310(1)(D)-310(N)(1)-310(N)(D) from the respective RU 208(1)-208(N) and such is included in a respective user device report 308(1)-308(D) for the user device 216(1)-216(D) (block 808 in FIG. 8). The TOA 312(1)(1)-312(1)(D)-312(N)(1)-312(N)(D) is also included in the user device report 308(1)-308(D) for the user device 216(1)-216(D). Then, to determine the geo-location of a user device 216(1)-216(N), the processing circuit 306 and/or DU 206 next select the RUs 208(1)-208(N) from the respective user device report 308(1)-308(D) that has the higher uplink power 310(1)(1)-310(1)(D)-310(N)(1)-310(N)(D) to more accurately determine the geo-location of the respective user device 216(1)-216(N) (block 810 in FIG. 8). A determined number of uplink power 310(1)(1)-310(1)(D)-310(N)(1)-310(N)(D) from the RUs 208(1)-208(N) are selected from the respective user device report 308(1)-308(D) at a time to be analyzed (block 812 in FIG. 8) to determine the geo-location of the user device 216(1)-216(N) more accurately (block 814 in FIG. 8).

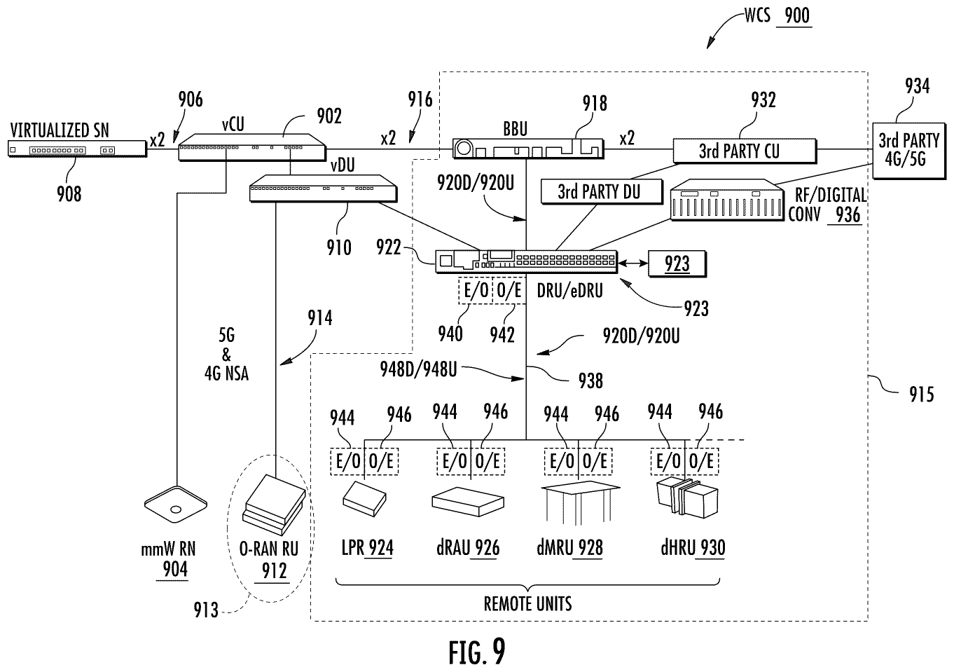

FIG. 9 is a schematic diagram of an exemplary multi-radio WCS 900 (“WCS 900”) that can include one or RAN systems implemented according to a RAN standard (e.g., O-RAN standard), including but not limited to the multi-radio WCS 300 in FIG. 3 and configured to determine the geo-location of active user devices in the WCS based on a user device report created for each user device that indicates the uplink power in a received uplink reference signal in each of a plurality of RUs as a result of a scheduled user device transmitting an uplink reference signal and TOA information regarding the received uplink reference signal in each of the RUs, according to any of the embodiments disclosed herein. The multi-radio WCS 900 supports both legacy 4G LTE, 4G/5G non-standalone (NSA), and 5G standalone communications systems. As shown in FIG. 9, a centralized services node 902 (which can be a CU described above) is provided that is configured to interface with a core network to exchange communications data and distribute the communications data as radio signals to remote units, which can be the RUs described above. In this example, the centralized services node 902 is configured to support distributed communications services to an mmWave radio node 904. The mmWave radio node 904 is an example of a wireless device that can be configured to selectively control whether received transmit channels are transmitted through an antenna array. Despite that only one mmWave radio node 904 is shown in FIG. 9, it should be appreciated that the multi-radio WCS 900 can be configured to include additional mmWave radio nodes 904, as needed. The functions of the centralized services node 902 can be virtualized through an x2 interface 906 to another services node 908. The centralized services node 902 can also include one or more internal radio nodes that are configured to be interfaced with a DU 910 (which can be a virtual DU and/or a DU described above) to distribute communications signals (e.g., communications channels) to a plurality of O-RAN RUs 912 (only one RU shown for convenience) that are configured to be communicatively coupled through an O-RAN interface 914. The O-RAN RUs 912 are another example of a wireless device that can be configured to selectively control whether received transmit channels are transmitted through an antenna array. The O-RAN RUs 912 are each configured to communicate downlink and uplink communications signals in the coverage cell(s) 913.

The centralized services node 902 can also be interfaced with a DCS 915 through an x2 interface 916. Specifically, the centralized services node 902 can be interfaced with a digital baseband unit (BBU) 918 in the DCS that can provide a digital signal source to the centralized services node 902. The digital BBU 918 can be configured to process user device reports based on TOA information from uplink communication signals received from the DRU 1622, as described above, to determine the geo-location of user devices in the multi-radio WCS 900. The digital BBU 918 may be configured to provide a signal source to the centralized services node 902 to provide electrical downlink communications signals 920D (electrical downlink communications signals 920D can include downlink channels) to a digital routing unit (DRU) 922 as part of a digital DAS. The DRU 922 is communicatively coupled to a processing circuit 923, which can be the processing circuit 306 in FIG. 3. The DRU 922 is configured to split and distribute the electrical downlink communications signals 920D to different types of remote wireless devices, including a low-power remote unit (LPR) 924, a radio antenna unit (dRAU) 926, a mid-power remote unit (dMRU) 928, and/or a high-power remote unit (dHRU) 930. The DRU 922 is also configured to combine electrical uplink communications signals 920U (electrical uplink communications signals 920U can include uplink channels) received from the LPR 924, the dRAU 926, the dMRU 928, and/or the dHRU 930 and provide the combined electrical uplink communications signals 920U to the digital BBU 918. The digital BBU 918 is also configured to interface with a third-party central unit 932 and/or an analog source 934 through a radio frequency (RF)/digital converter 936.

The DRU 922 may be coupled to the LPR 924, the dRAU 926, the dMRU 928, an/or the dHRU 930 via an optical fiber-based communications medium 938. In this regard, the DRU 922 can include a respective electrical-to-optical (E/O) converter 940 and a respective optical-to-electrical (O/E) converter 942. Likewise, each of the LPR 924, the dRAU 926, the dMRU 928, and the dHRU 930 can include a respective E/O converter 944 and a respective O/E converter 946.

The E/O converter 940 at the DRU 922 is configured to convert the electrical downlink communications signals 920D into optical downlink communications signals 920D for distribution to the LPR 924, the dRAU 926, the dMRU 928, and/or the dHRU 930 via the optical fiber-based communications medium 938. The O/E converter 950 at each of the LPR 924, the dRAU 926, the dMRU 928, and/or the dHRU 930 is configured to convert the optical downlink communications signals 920D back to the electrical downlink communications signals 920D. The E/O converter 944 at each of the LPR 924, the dRAU 926, the dMRU 928, and the dHRU 930 is configured to convert the electrical uplink communications signals 920U into optical uplink communications signals 920U. The O/E converter 942 at the DRU 922 is configured to convert the optical uplink communications signals 920U back to the electrical uplink communications signals 920U.

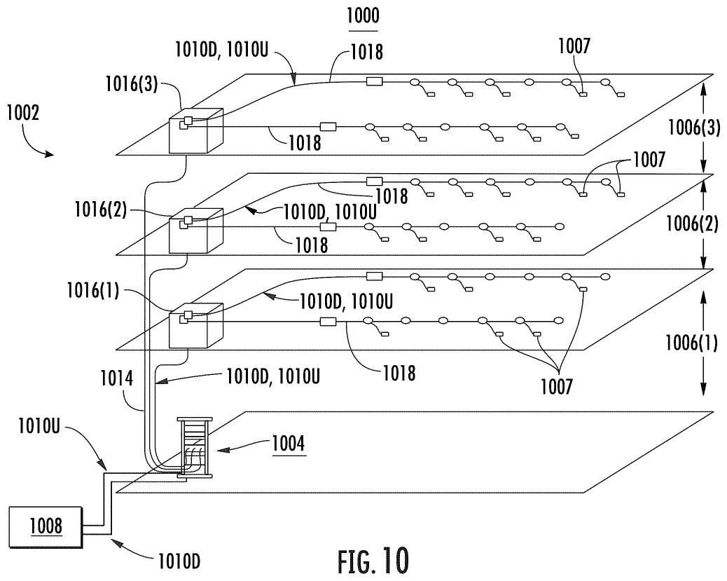

FIG. 10 is a partial schematic cut-away diagram of an exemplary building infrastructure 1000 that includes an exemplary multi-radio WCS 1002, including but not limited to the multi-radio WCS 300 in FIG. 3, wherein the multi-radio WCS 1002 includes multiple RANs 1004 implemented according to a RAN standard (e.g., O-RAN standard). The multi-radio WCS 1002 is configured to process user device reports based on TOA information from uplink communication signals, as described above, to determine geo-location of user devices in the multi-radio WCS 1002. The building infrastructure 1000 in this embodiment includes a first (ground) floor 1006(1), a second floor 1006(2), and a third floor 1006(3). The floors 1006(1)-1006(3) are serviced by one or more RANs 1004 to provide antenna coverage areas 1007 in the building infrastructure 1000. The RANs 1004 are communicatively coupled to a core network 1008 to receive downlink communications signals 1010D (downlink communications signals 1010D can include downlink channels) from the core network 1008. The RANs 1004 are communicatively coupled to a respective plurality of RUs 1012 to distribute the downlink communications signals 1010D to the RUs 1012 and to receive uplink communications signals 1010U (uplink communications signals 1010U can include uplink channels) from the RUs 1012, as previously discussed above. Any RU 1012 can be shared by any of the multiple RANs 1004.

The downlink communications signals 1010D and the uplink communications signals 1010U communicated between the RANs 1004 and the RUs 1012 are carried over a riser cable 1014. The riser cable 1014 may be routed through interconnect units (ICUs) 1016(1)-1016(3) dedicated to each of the floors 1006(1)-1006(3) that route the downlink communications signals 1010D and the uplink communications signals 1010U to the RUs 1012 and also provide power to the RUs 1012 via array cables 1018.

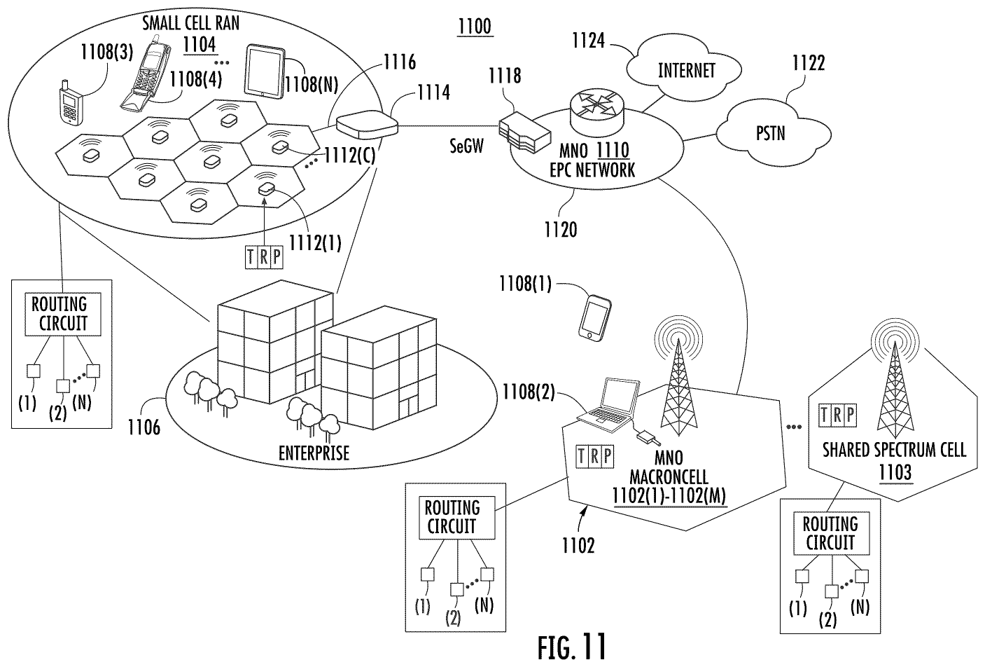

FIG. 11 is a schematic diagram of an exemplary mobile telecommunications multi-radio WCSs 1100 that can include, but is not limited to, the multi-radio WCS 300 in FIG. 3. The multi-radio WCS 1100 includes multiple RANs implemented according to a RAN standard (e.g., O-RAN standard). The multi-radio WCS 1100 is configured to process user device reports based on TOA information from uplink communication signals, as described above, to determine the geo-location of user devices in the multi-radio WCS 1100.

In this regard, multi-radio WCS 1100 includes exemplary macrocell RANs 1102(1)-1102(M) (“macrocells 1102(1)-1102(M)”) and an exemplary small cell RAN 1104 located within an enterprise environment 1106 and configured to service mobile communications between a user mobile communications device 1108(1)-1108(N) to a mobile network operator (MNO) 1110. A serving RAN for the user mobile communications devices 1108(1)-1108(N) is a RAN or cell in the RAN in which the user mobile communications devices 1108(1)-1108(N) have an established communications session with the exchange of mobile communications signals for mobile communications. Thus, a serving RAN may also be referred to herein as a serving cell. For example, the user mobile communications devices 1108(3)-1108(N) in FIG. 11 are being serviced by the small cell RAN 1104, whereas the user mobile communications devices 1108(1) and 1108(2) are being serviced by the macrocell 1102. The macrocell 1102 is an MNO macrocell in this example. The macrocell 1102 can be or include a wireless device(s) that can be configured to selectively control whether received transmit channels are transmitted through an antenna array of the wireless device. However, a shared spectrum RAN 1103 (also referred to as “shared spectrum cell 1103”) includes a macrocell in this example and supports communications on frequencies that are not solely licensed to a particular MNO, such as CBRS for example, and thus may service user mobile communications devices 1108(1)-1108(N) independent of a particular MNO. The macrocell 1102 can be or include a wireless device(s) that can be configured to selectively control whether received transmit channels are transmitted through an antenna array of the wireless device. The macrocell 1102 can be a wireless device that can be configured to selectively control whether received transmit channels are transmitted through an antenna array of the wireless device. For example, the shared spectrum cell 1103 may be operated by a third party that is not an MNO and wherein the shared spectrum cell 1103 supports CBRS. The MNO macrocell 1102, the shared spectrum cell 1103, and the small cell RAN 1104 may be neighboring radio access systems to each other, meaning that some or all can be in proximity to each other such that a user mobile communications device 1108(3)-1108(N) may be able to be in communications range of two or more of the MNO microcell(s) 1102, the shared spectrum cell 1103, and the small cell RAN 1104 depending on the location of the user mobile communications devices 1108(3)-1108(N).

In FIG. 11, the multi-radio WCS 1100 in this example is arranged as an LTE system as described by the Third Generation Partnership Project (3GPP) as an evolution of the GSM/UMTS standards (Global System for Mobile Communication/Universal Mobile Telecommunications System). It is emphasized, however, that the aspects described herein may also be applicable to other network types and protocols. The multi-radio WCS 1100 includes the enterprise environment 1106 in which the small cell RAN 1104 is implemented. The small cell RAN 1104 includes a plurality of small cell radio nodes 1112(1)-1112(C), which are wireless devices that can be configured to selectively control whether received transmit channels are transmitted through an antenna array of the wireless devices. Each small cell radio node 1112(1)-1112(C) has a radio coverage area (graphically depicted in the drawings as a hexagonal shape) that is commonly termed a “small cell.” A small cell may also be referred to as a femtocell or, using terminology defined by 3GPP, as a Home Evolved Node B (HeNB). In the description that follows, the term “cell” typically means the combination of a radio node and its radio coverage area unless otherwise indicated.

In FIG. 11, the small cell RAN 1104 includes one or more services nodes (represented as a single services node 1114) that manage and control the small cell radio nodes 1112(1)-1112(C). In alternative implementations, the management and control functionality may be incorporated into a radio node, distributed among nodes, or implemented remotely (i.e., using infrastructure external to the small cell RAN 1104). The small cell radio nodes 1112(1)-1112(C) are coupled to the services node 1114 over a direct or local area network (LAN) connection 1116 as an example, typically using secure IPsec tunnels. The small cell radio nodes 1112(1)-1112(C) can include multi-operator radio nodes. The services node 1114 aggregates voice and data traffic from the small cell radio nodes 1112(1)-1112(C) and provides connectivity over an IPsec tunnel to a security gateway (SeGW) 1111 in a network 1120 (e.g., evolved packet core (EPC) network in a 4G network, or 5G Core in a 5G network) of the MNO 1110. The network 1120 is typically configured to communicate with a public switched telephone network (PSTN) 1122 to carry circuit-switched traffic, as well as for communicating with an external packet-switched network such as the Internet 1124.

The multi-radio WCS 1100 also generally includes a node (e.g., eNodeB or gNodeB) base station, or “macrocell” 1102. The radio coverage area of the macrocell 1102 is typically much larger than that of a small cell where the extent of coverage often depends on the base station configuration and surrounding geography. Thus, a given user mobile communications device 1108(3)-1108(N) may achieve connectivity to the network 1120 (e.g., EPC network in a 4G network, or 5G Core in a 5G network) through either a macrocell 1102 or small cell radio node 1112(1)-1112(C) in the small cell RAN 1104 in the multi-radio WCS 1100.

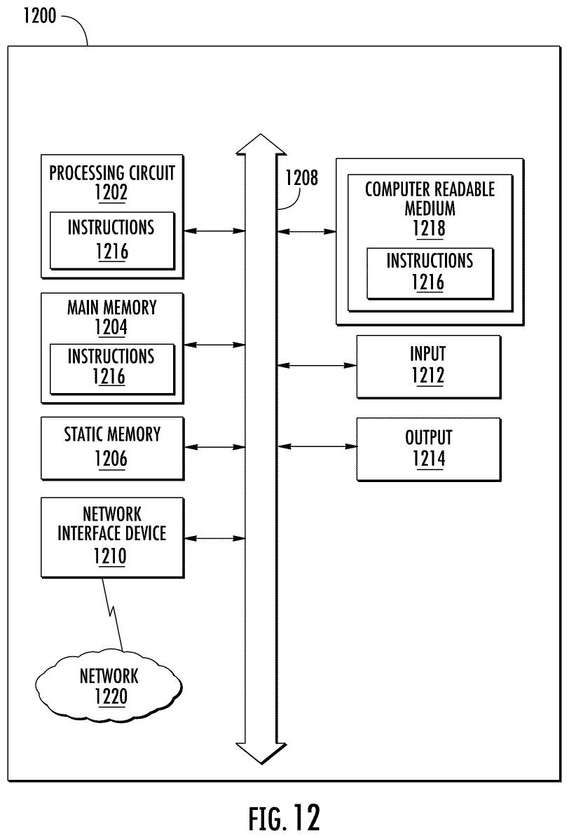

Any of the circuits, components, devices, modules described herein, can include or be included in a computer system 1200, such as that shown in FIG. 12, to carry out their functions and operations as described herein. With reference to FIG. 12, the computer system 1200 includes a set of instructions for causing the multi-operator radio node component(s) to provide its designed functionality, and the circuits discussed above. The multi-operator radio node component(s) may be connected (e.g., networked) to other machines in a LAN, an intranet, an extranet, or the Internet. The multi-operator radio node component(s) may operate in a client-server network environment, or as a peer machine in a peer-to-peer (or distributed) network environment. While only a single device is illustrated, the term “device” shall also be taken to include any collection of devices that individually or jointly execute a set (or multiple sets) of instructions to perform any one or more of the methodologies discussed herein. The multi-operator radio node component(s) may be a circuit or circuits included in an electronic board card, such as a printed circuit board (PCB) as an example, a server, a personal computer, a desktop computer, a laptop computer, a personal digital assistant (PDA), a computing pad, a mobile device, or any other device, and may represent, for example, a server, edge computer, or a user's computer. The exemplary computer system 1200 in this embodiment includes a processing circuit 1202 (e.g., processor). a main memory 1204 (e.g., read-only memory (ROM), flash memory, dynamic random-access memory (DRAM) such as synchronous DRAM (SDRAM), etc.), and a static memory 1206 (e.g., flash memory, static random access memory (SRAM), etc.), which may communicate with each other via a data bus 1208. Alternatively, the processing circuit 1202 may be connected to the main memory 1204 and/or static memory 1206 directly or via some other connectivity means. The processing circuit 1202 may be a controller, and the main memory 1204 or static memory 1206 may be any type of memory.

The processing circuit 1202 represents one or more general-purpose processing circuits such as a microprocessor, central processing unit, or the like. More particularly, the processing circuit 1202 may be a complex instruction set computing (CISC) microprocessor, a reduced instruction set computing (RISC) microprocessor, a very long instruction word (VLIW) microprocessor, a processor implementing other instruction sets, or processors implementing a combination of instruction sets. The processing circuit 1202 is configured to execute processing logic in instructions 1216 for performing the operations and steps discussed herein.

The computer system 1200 may further include a network interface device 1210. The computer system 1200 also may or may not include an input 1212 to receive input and selections to be communicated to the computer system 1200 when executing instructions. The computer system 1200 also may or may not include an output 1214, including but not limited to a display, a video display unit (e.g., a liquid crystal display (LCD) or a cathode ray tube (CRT)), an alphanumeric input device (e.g., a keyboard), and/or a cursor control device (e.g., a mouse).

The computer system 1200 may or may not include a data storage device that includes instructions 1216 stored in a computer-readable medium 1218. The instructions 1216 may also reside, completely or at least partially, within the main memory 1204 and/or within the processing circuit 1202 during execution thereof by the computer system 1200, the main memory 1204 and the processing circuit 1202 also constituting the computer-readable medium 1218. The instructions 1216 may further be transmitted or received over a network 1220 via the network interface device 1210.

While the computer-readable medium 1218 is shown in an exemplary embodiment to be a single medium, the term “computer-readable medium” should be taken to include a single medium or multiple media (e.g., a centralized or distributed database, and/or associated caches and servers) that store the one or more sets of instructions. The embodiments disclosed herein may be provided as a computer program product, or software, that may include a machine-readable medium (or computer-readable medium) having stored thereon instructions, which may be used to program a computer system (or other electronic devices) to perform a process according to the embodiments disclosed herein. The term “computer-readable medium” and “machine-readable medium” shall also be taken to include any medium that is capable of storing, encoding or carrying a set of instructions for execution by the processing circuit and that cause the processing circuit to perform any one or more of the methodologies of the embodiments disclosed herein. For example, a computer-readable medium or a machine-readable medium includes a machine-readable storage medium (e.g., read only memory (“ROM”), random access memory (“RAM”), magnetic disk storage medium, optical storage medium, flash memory devices, etc.), solid-state memories, optical media, magnetic media, and the like. Notwithstanding this broad definition, specifically excluded from this definition are electromagnetic carrier waves or other signals that have information encoded thereon or therein but lack tangible form.

The embodiments disclosed herein include various steps. The steps of the embodiments disclosed herein may be performed by hardware components or may be embodied in machine-executable instructions, which may be used to cause a general-purpose or special-purpose processor programmed with the instructions to perform the steps. Alternatively, the steps may be performed by a combination of hardware and software.

Unless specifically stated otherwise and as apparent from the previous discussion, it is appreciated that throughout the description, discussions utilizing terms such as “processing,” “computing,” “determining,” “displaying,” or the like, refer to the action and processes of a computer system, or similar electronic computing device, that manipulates and transforms data and memories represented as physical (electronic) quantities within the computer system's registers into other data similarly represented as physical quantities within the computer system memories or registers or other such information storage, transmission, or display devices.

The algorithms and displays presented herein are not inherently related to any particular computer or other apparatus. Various systems may be used with programs in accordance with the teachings herein, or it may prove convenient to construct more specialized apparatuses to perform the required method steps. The required structure for a variety of these systems will appear from the description above. In addition, the embodiments described herein are not described with reference to any particular programming language. It will be appreciated that a variety of programming languages may be used to implement the teachings of the embodiments as described herein.

Those of skill in the art will further appreciate that the various illustrative logical blocks, modules, circuits, and algorithms described in connection with the embodiments disclosed herein may be implemented as electronic hardware, instructions stored in memory or in another computer-readable medium and executed by a processor or other processing device, or combinations of both. The components and/or systems described herein may be employed in any circuit, hardware component, integrated circuit (IC), or IC chip, as examples. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends on the particular application, design choices, and/or design constraints imposed on the overall system. Skilled artisans may implement the described functionality in varying ways for each particular application, but such implementation decisions should not be interpreted as causing a departure from the scope of the present embodiments.

The various illustrative logical blocks, modules, and circuits described in connection with the embodiments disclosed herein may be implemented as electronic hardware, instructions stored in memory or in another computer-readable medium and executed by a processor or other processing device, or combinations of both. The various illustrative logical blocks, modules, and circuits described in connection with the embodiments disclosed herein may be implemented with a processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein, as examples. A controller may be a processor. A processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The embodiments disclosed herein may be embodied in hardware and in instructions that are stored in hardware, and may reside, for example, in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, or any other form of computer-readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary embodiments herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary embodiments may be combined. Those of skill in the art will also understand that information and signals may be represented using any of a variety of technologies and techniques. For example, data, instructions, commands, information, signals, bits, symbols, and chips, that may be references throughout the above description, may be represented by voltages, currents, electromagnetic waves, magnetic fields, or particles, optical fields or particles, or any combination thereof.

Unless otherwise expressly stated, it is in no way intended that any method set forth herein be construed as requiring that its steps be performed in a specific order. Accordingly, where a method claim does not actually recite an order to be followed by its steps, or it is not otherwise specifically stated in the claims or descriptions that the steps are to be limited to a specific order, it is in no way intended that any particular order be inferred.

It will be apparent to those skilled in the art that various modifications and variations can be made without departing from the spirit or scope of the invention. Since modifications combinations, sub-combinations and variations of the disclosed embodiments incorporating the spirit and substance of the invention may occur to persons skilled in the art, the invention should be construed to include everything within the scope of the appended claims and their equivalents.

We claim:

1. A wireless communications system (WCS), comprising:
a plurality of radio units (RUs), each having a cell coverage area and each configured to:
transmit a downlink communication signal to a user device among a plurality of user devices in its cell coverage area;
receive an uplink communication signal from the user device; and
receive an uplink reference signal from the user device;
the WCS configured to:
schedule each of the plurality of user devices as a scheduled user device to transmit an uplink reference signal at different times;
each RU of the plurality of RUs further configured to:
measure uplink power in the received uplink reference signal from the scheduled user device; and
communicate the measured uplink power for the RU and the scheduled user device;
the WCS further configured to, for each scheduled user device of the plurality of user devices:
receive the measured uplink power for the scheduled user device from each RU of the plurality of RUs;
correlate time of arrival (TOA) of the uplink reference signal received in each RU to the received measured uplink power for each RU;
generate a user device report for the scheduled user device based on the received measured uplink power in the uplink reference signal for each RU and the TOA of the uplink reference signal for each RU; and
determine geo-location of the plurality of user devices within the WCS based on the user device report for the plurality of user devices.

2. The WCS of claim 1 further configured to generate the user device by being configured to, for each RU of the plurality of RUs:
determine if the measured uplink power in the RU for the scheduled user device exceeds a noise threshold level;
in response to determining the measured uplink signal power in the RU for the scheduled user device exceeds the noise threshold level;
accept the measured uplink signal power in the RU for the scheduled user device; and
generate the user device report for the scheduled user device based on the accepted measured uplink power in each RU of the plurality of RUs for the scheduled user device.

3. The WCS of claim 1, wherein the measured uplink power comprises a reference signal strength indicator (RSSI).

4. The WCS of claim 1 further configured to configure each of the plurality of user devices to transmit the uplink reference signal.

5. The WCS of claim 1, wherein the uplink reference signal is a sounding reference signal (SRS).

6. The WCS of claim 1, configured to each of the plurality of user devices to transmit the uplink reference signal comprising a wideband sounding reference signal (SRS).

7. The WCS of claim 1, wherein each RU of the plurality of RUs is configured to measure the uplink power in the received uplink reference signal from the scheduled user device in a time domain.

8. The WCS of claim 1, wherein each RU of the plurality of RUs is further configured to transform the received uplink communication signal into a frequency domain uplink communication signal after measuring the uplink power in the received uplink reference signal.

9. The WCS of claim 1, further comprising:
a distribution unit (DU) configured to:
distribute the downlink communication signal from a service provider to the plurality of RUs;
receive a plurality of uplink communication signals from the plurality of RUs; and
distribute the plurality of uplink communication signals to the service provider;
the DU further configured to:
schedule each of the plurality of user devices as a scheduled user device to transmit the uplink reference signal at different times.

10. The WCS of claim 9, wherein the DU is further configured to determine the geo-location of the plurality of user devices within the WCS based on the user device report for the plurality of user devices.

11. The WCS of claim 9, further comprising the processing circuitry is coupled to the DU, wherein the processing circuitry is configured to:
receive the measured uplink power for the scheduled user device from each RU of the plurality of RUs; and
correlate the TOA of the uplink reference signal received in each RU to the received measured uplink power for each RU; and
generate the user device report for the scheduled user device based on the received measured uplink power in the uplink reference signal for each RU and the TOA of the uplink reference signal for each RU.

12. The WCS of claim 9, wherein the DU comprises the processing circuit.

13. The WCS of claim 9, further comprising:
a radio aggregation unit coupled to the DU, the radio aggregation unit configured to:
receive the downlink communication signal from the DU;
distribute the downlink communication signal to each RU of the plurality of RUs;
receive a plurality of uplink communication signals from the plurality of RUs;
combine the received plurality of uplink communication signals into a combined uplink communication signal;
the DU further configured to:
receive the uplink communication signal by being configured to receive the combined uplink communication signal from the radio aggregation unit; and
distribute the uplink communication signal by being configured to distribute the combined uplink communication signal to the service provider.

14. The WCS of claim 13, wherein the DU is further configured to determine the TOA of the uplink reference signal received in each RU based on recording the combined uplink communication signal as a function of time and correlating power in recorded combined uplink communication signal to the measured uplink power of the uplink reference signal in each RU.

15. The WCS of claim 1, wherein the processing circuitry comprises a computer server.

16. A method for determining geo-location of a plurality of user devices in a wireless communication system (WCS), comprising:
scheduling each of a plurality of user devices as a scheduled user device to transmit an uplink reference signal at different times;
for each scheduled user device of the plurality of user devices:
receiving an uplink reference signal from the scheduled user device;
measuring uplink power in the received uplink reference signal from the scheduled user device in each RU of a plurality of radio units (RUs);
receiving the measured uplink power for the scheduled user device from each RU of the plurality of RUs; and
correlating time of arrival (TOA) of the uplink reference signal received in each RU to the received measured uplink power for each RU; and
generating a user device report for the scheduled user device based on the received measured uplink power in the uplink reference signal for each RU and the TOA of the uplink reference signal for each RU; and
determining geo-location of the plurality of user devices within the WCS based on the user device report for the plurality of user devices.

17. The method of claim 16 wherein generating the user device comprises, for each RU of the plurality of RUs:
determining if the measured uplink power in the RU for the scheduled user device exceeds a noise threshold level;
in response to determining the measured uplink signal power in the RU for the scheduled user device exceeds the noise threshold level;
accepting the measured uplink signal power in the RU for the scheduled user device; and
generating the user device report for the scheduled user device based on the accepted measured uplink power in each RU of the plurality of RUs for the scheduled user device.

18. The method of claim 17, wherein the measured uplink power comprises a reference signal strength indicator (RSSI).

19. The method of claim 16 further configured to configure each of the plurality of user devices to transmit the uplink reference signal.

20. The method of claim 16, wherein the uplink reference signal is a sounding reference signal (SRS).

21. The method of claim 16, wherein measuring the uplink power comprises measuring the uplink power in the received uplink reference signal from the scheduled user device in a time domain in the plurality of RUs.

22. The method of claim 16, further comprising transforming the received uplink communication signal into a frequency domain uplink communication signal after measuring the uplink power in the received uplink reference signal in each of the plurality of RUs.
